(19) United States
(12) Patent Application Publication
(10) Pub. No.: US 2006/0252025 A1
(43) Pub. Date: Nov. 9, 2006

(54) Low temperature deparaffinization

(75) Inventors: Hiro Nitta, Oro Valley, AZ (US); Thomas M. Grogan, Tucson, AZ (US); Kenji Sonoda, Ichikawa-Shi (JP); Eiko Munechika, Tokyo (JP)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Ventana Medical Systems, Inc.

(21) Appl. No.: 11/319,118

(22) Filed: Dec. 21, 2005

Related U.S. Application Data
(60) Provisional application No. 60/640,477, filed on Dec. 30, 2004.

(51) Int. Cl. A01N 1/02; G01N 1/30

(52) U.S. Cl. 435/2; 435/40.5

(57) ABSTRACT

Methods and apparatuses for gently removing embedding media from biological samples at temperatures below the embedding medium melting point with liquid composition using batch methods or automated instruments prior to immunohistochemical (IHC), in situ hybridization (ISH) or other special staining or histochemical or cytochemical manipulations.

This application claims priority to U.S. Provisional Patent Application Ser. No. 60/640,477 filed on Dec. 30, 2004.

### BACKGROUND OF THE INVENTION

(1) Field of the Invention

The present invention relates to methods and apparatuses for using liquid compounds and preferably alkanes to gently remove embedding media from biological samples at temperatures below the embedding medium melting point. The methods can be performed batchwise or using automated instruments prior to immunohistochemical (IHC), in situ hybridization (ISH) or other special staining or histochemical or cytochemical manipulations. The present invention also relates to methods and apparatus for low temperature processing of cells or tissues so as to increase the detection of mRNA ISH.

(2) Description of the Art

The diagnosis of diseases based on the interpretation of tissue or cell samples taken from a diseased organism has expanded dramatically over the past few years. In addition to traditional histological staining techniques and immunohistochemical assays, in situ techniques such as in situ hybridization and in situ polymerase chain reaction are now used to help diagnose disease states in humans and to elucidate the gene expression sites in tissue sections. Thus, there are varieties of techniques that can assess not only cell morphology, but also the presence of specific molecules (e.g., DNA, RNA and proteins) within cells and tissues. Each of these techniques requires that sample cells or tissues undergo preparatory procedures that may include fixing the sample with chemicals such as an aldehyde (such as formaldehyde, glutaraldehyde), formalin substitutes, alcohol (such as ethanol, methanol, isopropanol) or embedding the sample in inert materials such as paraffin, celloidin, agars, polymers, resins, cryogenic media or a variety of plastic embedding media (such as epoxy resins and acrylics). Other sample tissue or cell preparations require physical manipulation such as freezing (frozen tissue section) or aspiration through a fine needle (fine needle aspiration (FNA)).

Regardless of the tissue or cell sample or its method of preparation or preservation, the goal of the technologist is to obtain accurate, readable and reproducible results that permit the accurate interpretation of the data. One way to provide accurate, readable and reproducible data is to prepare the tissue or cells in a fashion that optimizes the results of the test regardless of the technique employed. In the case of immunohistochemistry (IHC) and in situ hybridization (ISH) techniques this means increasing the amount of signal obtained from the specific antibodies and probes. In the case of histochemical staining it may mean increasing the intensity of the stain or increasing staining contrast.

One way to improve testing results is to increase the signal obtained from a given sample. In general, an increased signal can be obtained by increasing the accessibility of a given molecule for its target. Targets within cells can be made more accessible by increasing the permeability of the cell, permitting a greater number of molecules entry into the cell and thereby increasing the probability that the molecule will “find” its target. Such increased permeability is especially important for techniques such as ISH, IHC, histochemistry and cytochemistry.

Tissues and cells are embedded in a variety of inert media (paraffin, celloidin, OCT™, agar, plastics or acrylics etc.) to help preserve them for future analysis. Many of these inert materials are hydrophobic. In contrast, the reagents used for histological and cytological applications are predominantly hydrophilic. Therefore, in order for the reagents to gain access to embedded biological materials, the inert medium may need to be removed from the biological sample prior to testing. For example, it is a standard prior art procedure to prepare paraffin embedded and/or infused tissue sections for subsequent testing by removing the paraffin from the tissue section by passing the slide through various organic solvents such as toluene, xylene, limonene or other suitable solvents. These organic solvents are very volatile and potentially toxic and can cause a variety of problems including requiring special processing (e.g., deparaffinization is performed in ventilated hoods) and requires special waste disposal procedures. The use of these organic solvents increases the cost of analysis and exposure risk associated with each tissue sample tested and has serious negative effects to individuals exposed to them and to the environment.

An alternate method for removing embedded and/or infused paraffin from biological samples is disclosed in U.S. Pat. No. 6,544,798, the specification of which is incorporated herein by reference. The '798 patent discloses heating the paraffin embedded or infused biological sample to a temperature above the melting point of the paraffin before or following the application of a liquid paraffin immiscible solution—such as water—to the biological sample. Heating the sample to a temperature above the melting point of the embedded and/or infused paraffin liquefies the paraffin which floats to the top of the immiscible liquid where it is easily separated from the biological sample. While this method is less destructive to biological samples in comparison to solvent deparaffinization, the step of heating the biological sample to a temperature above the melting point of the infusing or embedding medium can negatively impact the signal obtainable from sensitive targets such as mRNA.

Dehydration of targeted tissues during tissue processing steps can also negatively impact their enhancement and detection. U.S. Pat. No. 5,225,325, the specification of which is incorporated herein by reference, discloses a method for inhibiting tissue dehydration by applying a LIQUID COVERSLIP™ layer—an evaporation inhibitor liquid—on top of the wet or covered tissue. The evaporation-inhibiting—liquid layer is applied to a hydrated tissue sample after the embedding medium is removed from the sample. According to the '325 patent, the evaporation inhibiting liquid is less dense than the water covering the tissue sample and is preferably a non-aromatic hydrocarbon having from 6 to 18 carbon atoms. As a result, aqueous reagents may be applied to biological samples located on slides while the evaporation inhibiting liquid layer remains in place atop the aqueous buffer covering the sample. The more dense aqueous solution(s) containing stains pass through the evaporation inhibiting liquid layer and contact the biological samples. Using this method, tissue samples can be subjected to high temperature processes such as ISH with minimal to no sample dehydration.

Despite these advances in automated and batch biological sample processing, there remains a need for processing techniques for gently removing inert media from sample tissues in an automated fashion.

### SUMMARY OF THE INVENTION

The methods of the present invention permit a) automated removal of a paraffin-based embedding medium from biological samples without the use of strong organic solvents, without aggressive washing, and without heating the embedded or infused biological samples to temperatures in excess of the embedding or infusing medium melting temperatures.

The methods of this invention were discovered as a result of the faulty operation of an automated ISH apparatus. In normal operation, a liquid embedding medium immiscible liquid is applied to a biological sample heated to a temperature above the embedding medium's melting point. The liquefied embedding medium is washed from the biological sample with several sequential applications of heated immiscible liquid. The heated immiscible liquid tends to have a harsh effect on the biological sample. The inventors identified an automated ISH apparatus that performed exceptionally well when used for mRNA ISH. The inventors discovered that the apparatus was not operating as intended as described above. Instead of using an immiscible liquid to wash the liquefied embedding medium from the biological sample, the apparatus applied a nonpolar liquid at a temperature lower than the embedding medium melting point to the embedded biological samples. Thus the samples were processed without the high temperature immiscible liquid washing steps. The inventors thus discovered that embedded biological samples could be gently deparaffinized at temperatures lower than the melting point temperatures of the paraffin-based embedding medium and that that the resulting deparaffinized biological samples were surprisingly intact for subsequent processing and that the cell nucleuses were especially intact for mRNA ISH.

The methods of this invention provide many improvements over prior art deparaffinization methods. The methods of this invention are gentle and can be performed at or near room temperatures, on biological samples located on glass slides in an automated system to expose the cells and increase permeability of the cytological or histological specimens, thereby increasing sample readability and improving interpretation of test data. The methods of the present invention can be used for improving the stainability and readability of most histological and cytological samples used in conjunction with cytological and histological staining techniques. In addition, the methods of the present invention are especially useful for enhancing the detection in mRNA ISH procedures.

One aspect of this invention is a method for removing paraffin-based embedding medium from a paraffin-embedded biological sample, the method comprising the steps of: (a) loading a plurality of paraffin-embedded biological samples into an automated tissue staining apparatus; (b) placing a paraffin-solubilizing liquid alkane having from 10 to 16 carbon atoms into direct contact with the biological sample; (c) maintaining the liquid alkane in contact with the biological sample at a temperature less than the melting point of the paraffin-based embedding medium for a time sufficient for at least a portion of the paraffin-based embedding medium to become soluble in the liquid alkane; and (d) removing the liquid alkane including solubilized paraffin-based embedding medium from the biological sample to form a deparaffinized biological material wherein the temperature of the biological sample is does not equal or exceed the embedding medium's melting point during steps (b) and (c).

One embodiment of this and other aspects of the invention is controlling the biological sample temperature such that it is never equal to or greater than the embedding medium's melting point during step (a) & (b).

In another embodiment of this and other aspects of the invention, the biological sample temperature is maintained at essentially room temperature.

In yet another embodiment of this and other aspects of the invention, the liquid composition is a non-aromatic hydrocarbon. In one preferred embodiment, the liquid composition is a non-aromatic hydrocarbon having from 6 to 18 carbon atoms. In another preferred embodiment, the non-aromatic hydrocarbon is an alkane and more preferably a linear alkane having from 10 to 16 carbon atoms such as dodecane or pentadecane.

In still another embodiment of this and other aspects of the invention, mineral oil is added to the liquid composition.

In yet another embodiment of this and other aspects of the invention, steps (a) and (b) are repeated at least once following step (c). Alternately, or in addition, the deparaffinized biological material may be further manipulated by methods selected from immunohistochemical (IHC) methods, in situ hybridization (ISH) methods, special staining methods, histochemical methods, cytochemical methods, or the deparaffinized biological material may be contacted with polynucleotide probes that are complementary to target mRNA sequences in situ.

Another aspect of this invention are methods for deparaffinizing biological samples embedded with a paraffin-based embedding medium comprising the steps of: (a) placing at least one biological sample embedded with a paraffin-based embedding medium on a support and loading the support into an automated deparaffinization apparatus; (b) directing a liquid composition comprising a non-polar organic solvent into contact with the biological sample; (c) maintaining the liquid composition in contact with the paraffin-embedded biological sample for a time sufficient for at least a portion of the paraffin-based embedding medium to become solubilized in the liquid composition; and (d) removing the liquid composition including soluble embedding medium from the biological sample to form a deparaffinized biological material, wherein steps (b), (c) and (d) are performed by the automated deparaffinization apparatus and wherein the temperature of the biological sample is does not equal or exceed the embedding medium's melting point during steps (b) and (c).

Still another aspect of this invention are methods of detecting RNA/DNA in paraffin-embedded biological samples comprising: (a) contacting a paraffin-embedded biological sample with a paraffin-solubility nonpolar organic solvent at a temperature below the melting point of the paraffin; (b) gently stirring the paraffin-solubilizing nonpolar organic solvent to enhance the solubilization of the paraffin; (c) removing the paraffin-solubilizing nonpolar organic solvent; (d) exchanging the removing nonpolar organic solvent in the deparaffinized biological sample with an aqueous medium; and (e) contacting the deparaffinized biological sample with a polynucleotide probe capable of being detected.

### DESCRIPTION OF THE FIGURES

This patent or application file contains at least one drawing executed in color. Copies of this patent or patent application publication with color drawing(s) will be provided by the Office upon request and payment of the necessary fee.

FIG. 1 is a perspective view of an apparatus useful for automating methods of the present invention shown with the slide hood open and the carousel door removed.

FIG. 2 is a perspective view of an apparatus useful for automating methods of the present invention shown in conjunction with a computer and other instruments with which it operates.

FIG. 3 is an exploded view of an apparatus useful for automating methods of the present invention.

FIG. 4 is a perspective view of an apparatus useful for automating methods of the present invention shown with a reagent dispenser.

FIGS. 5A & 5B are human lung sections stained with AFB III 1 special stain wherein the sections were deparaffinized using xylene (FIG. 5A) or using the methods of this invention (FIG. 5B).

FIGS. 6A-6C are VEGF mRNA ISH results of mouse kidney sections deparaffinized manually with xylene (FIG. 6A); using a prior art deparaffinization method disclosed in U.S. Pat. No. 6,544,798 (FIG. 6B) and using a deparaffinization method of this invention (FIG. 6C).

FIGS. 7A-7C are sections of human tissue processed using a CD20 IHC detection method wherein the sections were deparaffinized manually using xylene (FIG. 7A), using a deparaffinization method of U.S. Pat. No. 6,544,798 (FIG. 7B), or using a deparaffinization method of the present invention (FIG. 7C).

### DESCRIPTION OF THE CURRENT EMBODIMENT

The present invention relates to methods for deparaffinzing biological samples for further processing in histological or cytological testing procedures by removing the media embedding the biological sample without using toxic organic solvents, greatly elevated temperatures or harsh washing procedures.

One embodiment of the present invention relates to the exposing of biological samples by removing the inert materials in which biological samples have been embedded for preservation and support. In this embodiment of the present invention, inert embedding materials, such as paraffin or paraffin based embedding materials are removed from biological samples by exposing the biological samples to a liquid composition comprising a paraffin-solubilizing non-polar organic solvent at a temperature below the melting point of the embedding material for a period of time sufficient to remove enough paraffin-based embedding material from the sample to sufficiently expose the biological sample to subsequent tissue processing steps.

The term “embedding material” is defined herein to refer to inert paraffin-based materials that are used to infuse and/or embed biological materials. Embedding materials useful in this invention must be at least partially soluble in the liquid compositions identified below at temperatures below the melting point of the embedding material. Preferred embedding materials are paraffinic based embedding materials.

The term “deparaffinization” is broadly defined herein to refer to the removal of any type of embedding material from an embedded and/or infused biological sample infused and/or embedded with a paraffin-based embedding material.

The term “liquid composition” is defined herein broadly to refer to any liquid composition comprising a non-polar organic solvent in which an embedding material is at least partially soluble at a temperature below the paraffin-based embedding material's melting point.

The term “nonpolar organic solvent” refers to nonpolar hydrocarbons or a mixture of hydrocarbons (e.g. as from a petroleum distillate) that has a boiling point well above room temperature of 25° C., preferably above 110° C., more preferably from about 140° C. to about 250° C., that is in liquid phase at the temperatures used with the present invention (usually 15 to 50° C.) and that is capable of dissolving paraffin used for embedding biological specimens. The nonpolar organic solvent can be a complex mixture of long-chain linear and branched alkane hydrocarbons containing for example esters of fatty acids and higher glycols. The solubility of paraffin in the solvent at 25° C. is typically at least 0.1 gram paraffin per 1 liter of solvent, preferably 0.1 gram per 100 ml of solvent, more preferably; 0.1 gram per 10 ml of solvent, and most preferably capable of dissolving an amount of paraffin equal to about 50% of the solvent by solution weight.

Non-limiting examples of nonpolar organic solvents include aromatic hydrocarbons, aliphatic hydrocarbons, terpenes, other oils, and petroleum distillates. Preferred nonpolar organic solvents have little or no toxic effects. Furthermore preferred solvents are those not classified by the Environmental Protection Agency as hazardous waste. A preferred paraffin-solubilizing solvent furthermore has a flash point higher than about 60° C. which minimizes flammability. A preferred solvent furthermore lacks toxicity, carcinogenicity, and corrosiveness. An isoparaffinic hydrocarbon is an example of a preferred paraffin-solubilizing solvent, in part because of its lack of toxicity, carcinogenicity, corrosiveness and flammability. Preferred isoparaffins are branched aliphatic hydrocarbons with a carbon skeleton length ranging from approximately C10 to C15, or mixtures thereof. One preferred isoparaffin hydrocarbon mixture has a flashpoint of about 74° C. Another preferred paraffin-solubilizing solvent is a mixture of C10 to C50 branched or linear hydrocarbon chains having a distillation range from a boiling point of 150° C. to about 250° C., and has the general formula of Cⁿ H₍₂ₙ₊ₘ₎ where n=10-50 and m=0-4. Even more preferred are oils of a medium chain alkane family such as decane to hexadecane (C₁₀ to C₁₆). A preferred medium chain alkane is a C₁₅ alkane such as pentadecane.

Particularly preferred nonpolar organic solvents include NORPAR® 15, mineral spirits, or LIQUID COVERSLIP™ from Ventana. NORPAR® 15 is a high (>95%) normal paraffin hydrocarbon fluid (ExxonMobil Chemical) nominally comprising linear C15, with low volatility and a high boiling point. Mineral spirits comprising short chain linear and branched aliphatic hydrocarbons is another preferred paraffin-solubilizing organic solvent. A preferred terpene is limonene. Other terpenes that can be used include terpins, terpinenes and terpineols. Less preferably the solvent is an aromatic hydrocarbon solvent such as an alkylbenzene, e.g. toluene, or a dialkylbenzene, e.g. xylene. Toluene and xylene are less preferred because of their toxicity and rating as hazardous waste. Furthermore, as discussed below, even when xylene or toluene are used in embodiments of the invention, subsequent alcohol washes are eliminated and replaced with a non-hazardous aqueous wash solution.

The liquid compositions of this invention may be used alone or in combination with mineral oil depending upon the temperature at which the deparaffinization occurs. The term “mineral oil” is used in accordance with its ordinary meaning herein to refer to a liquid mixture of hydrocarbons obtained from petroleum. In a preferred embodiment, the inventors have discovered that NORPAR® 15 works well alone at low temperatures in removing paraffin-based embedding media from biological samples. They have also discovered that a combination of mineral oil and NORPAR® 15 is effective for removing paraffin-based embedding media from biological samples when temperatures above room temperature but lower than the embedding material melting point temperature are employed in removing the embedding medium from biological samples. NORPAR® 15 may be combined with liquid compositions of this invention at a volume ratio of from 1:100 to 100:1 with a ratio of about 1:1 being preferred.

The methods of the present invention may be performed at a variety of temperatures ranging from about room temperature (15 to 30° C.) up to a temperature slightly below that of the melting point of the embedding medium. The liquid composition is allowed to contact the embedding medium containing biological sample for a time sufficient to remove enough of the paraffin-based embedding media to expose the biological sample to further processing and enhancement. Generally, the. liquid composition will contact the embedding medium for a period of time ranging from about 1 minute to about 30 minutes or more and preferably from about 5 to about 15 minutes.

The embedding material is at least slightly soluble in the liquid composition at room temperature in order for the present method to be most effective. Therefore, the preferred liquid alkanes disclosed above are especially useful in removing paraffin based embedding materials from biological samples. Once the desired amount of the embedding material has become solubilized in the liquid composition, the biological sample is washed to remove the liquid composition/embedding material solution after which the biological sample is available for subsequent antigen retrieval or target detection, and staining steps.

In one aspect of the deparaffinization method of the present invention, the liquid composition is applied a single time to a biological sample in order to expose the biological sample for subsequent procedures. In an alternative embodiment, a liquid composition can be applied several times to the biological samples, and for example, each application of the liquid composition can be followed by a wash step, in order to more effectively remove the embedding material from the biological sample. In either embodiment, the biological material also may be subjected to varying temperatures in order to maximize the amount of embedding material that is removed from the biological material. For example, the temperature of the biological sample can be increased each time the biological sample is contacted with a liquid composition. Alternatively, the biological sample temperature can be decreased in subsequent liquid composition contacting steps. Other manipulations of the biological sample that improve the removal of the embedding medium from the biological sample may be employed in the methods of this invention. For example, the liquid composition may be agitated when in contact with the biological sample, or increased or reduced pressures may be used to enhance the solubility of the embedding material in the liquid composition.

The methods of this invention may be performed manually in a batch or continuous manner or on an automated platform. Moreover, the methods may be performed on biological samples located on or in a variety of containers such as glass slides, cuvettes, microarray plates and so forth. In a preferred method of the present invention, paraffin-embedded biological samples located on glass microscopic slides are processed in an automated staining instrument such as the instruments described in U.S. Pat. Nos. 6,054,759, 5,595,707, 6,405,609, and 6,296,809 the specifications of each which are each incorporated herein by reference, and instruments such as the BenchMark®, NexES®, Discovery®, and EOS instruments manufactured by Ventana Medical Systems, Inc. (Tuscon Ariz.).

In the methods of the present invention, a liquid composition, as described above is applied to the biological sample and the liquid composition is allowed to contact the biological sample for a time sufficient to remove embedding material from the biological sample thereby exposing the biological sample for subsequent processing. In particular embodiments, the liquid composition is allowed to contact the biological sample for a time sufficient to remove substantially all of the embedding material from the sample.

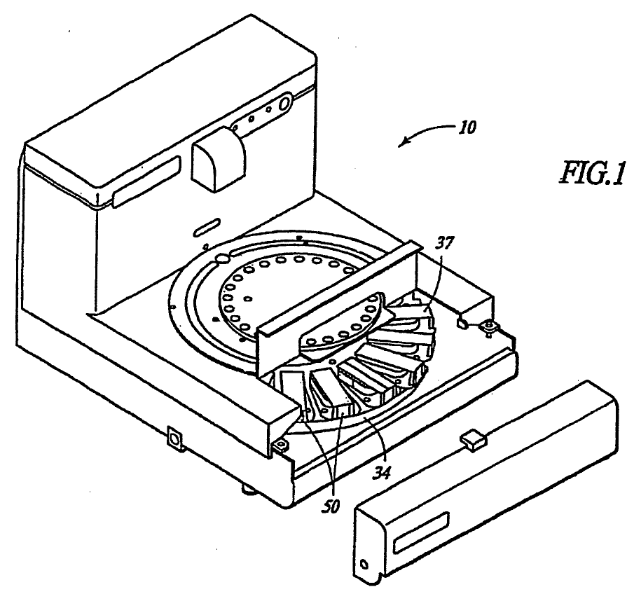

An example of an apparatus that is useful for automating the method of this invention is discussed with reference to FIGS. 1-4 wherein like parts are designated by like reference numerals throughout. There is illustrated in FIG. 1 a perspective view of the molecular pathology apparatus which is designated generally by reference numeral 10, also known commercially as the NexES® special stains instruments. Apparatus 10 is designed to automatically stain or otherwise treat tissues mounted on microscope slides with chemicals known as “special” stains, and/or other reagents associated therewith in a desired sequence for particular times, time and at set temperatures. Tissue sections so stained or treated can then to be viewed under a microscope for purposes of patient diagnosis, prognosis, or treatment, or to determine for example a correlation between the gene expression and tissue morphology.

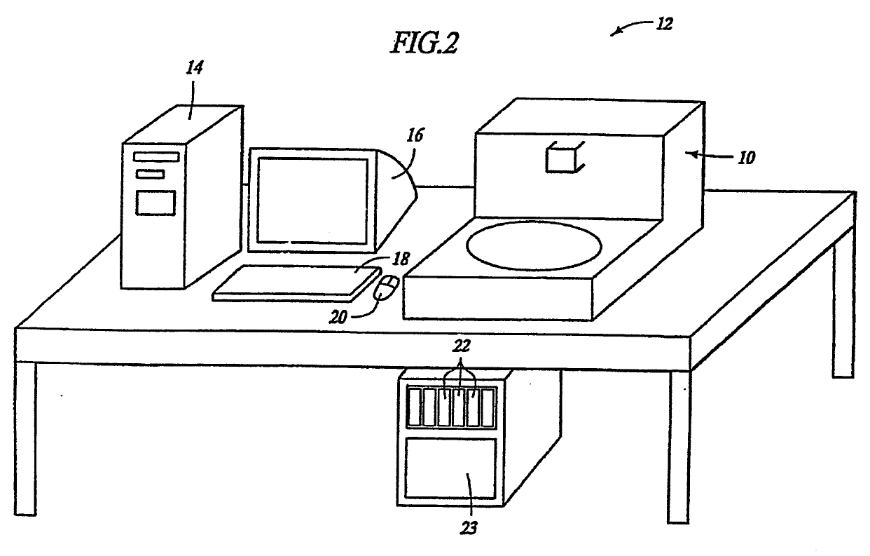

In one embodiment, apparatus 10 functions as the staining module of a system 12 (FIG. 2) which also comprises a host computer 14 preferably a personal computer, monitor 16, keyboard 18, mouse 20, bulk fluid containers 22, waste container 23 and related equipment. Additional staining modules or other instruments may be added to system 12 to form a network with computer 14 functioning as a server. Alternatively, some or all of these separate components could be incorporated into apparatus 10 making it a stand-alone instrument.

A preferred configuration of apparatus 10 as well as system 12 is generally described in U.S. Pat. No. 6,045,759, the specification of which is incorporated herein by reference as well as in the Ventana NexES® User's Guide available from Ventana Medical Systems, Inc. (Tuscon, Ariz.), the contents of which is incorporated herein by reference. In brief, apparatus 10 is a microprocessor-controlled staining module that automatically applies chemical and biological reagents to tissue mounted on standard glass microscope slides. A carousel supporting radially positioned glass slides is revolved by a stepper motor to place each slide under one of a series of reagent dispensers. Apparatus 10 controls dispensing, washing, mixing, and heating to optimize reaction kinetics. The computer controlled automation permits use of apparatus 10 in, a walk-away manner, i.e. with little manual labor.

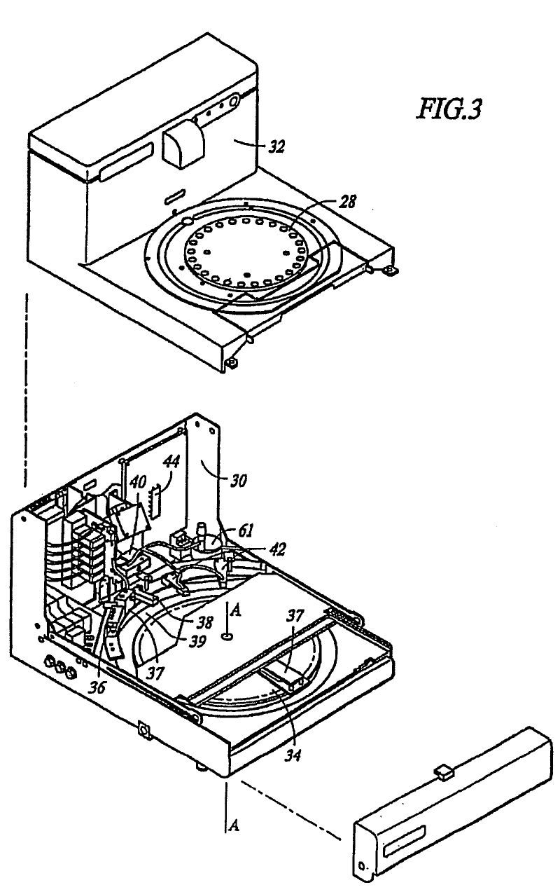

More particularly with reference to FIG. 3, apparatus 10 comprises a housing formed of a lower section 30 removably mounted or hinged to an upper section 32. A slide carousel 34 is mounted within lower section 30 for rotation about axis A-A. A plurality of thermal platforms 50 may be mounted radially about the perimeter of carousel 34 upon which standard glass slides with tissue samples may be placed. Carousel 34 is preferably constructed of stainless steel. Also housed within apparatus 10 are wash dispense nozzles 36, liquid composition dispense nozzle 37, fluid knife 38, wash volume adjust nozzle 39, bar code reader mirror 40, and air vortex mixers 42 the details of which are discussed hereinafter.

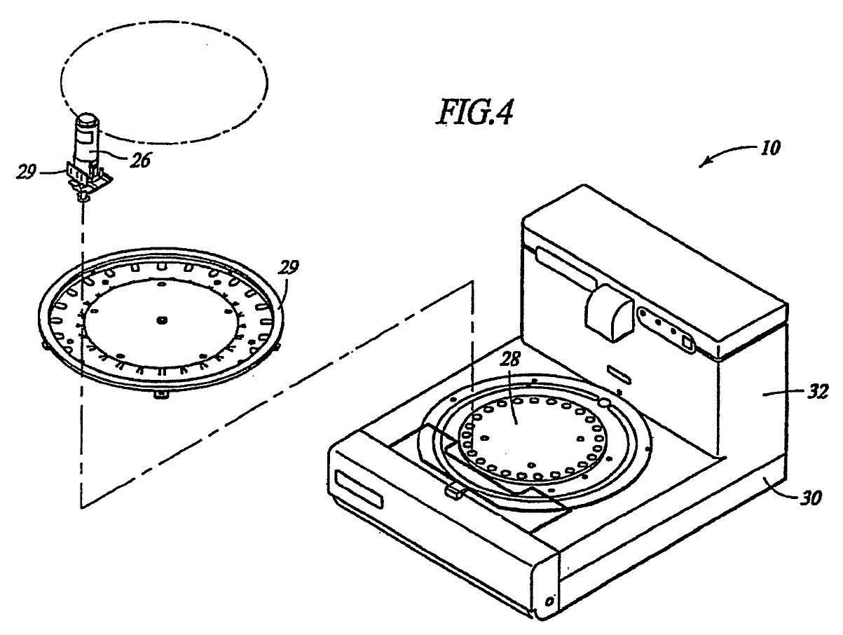

Rotatably mounted atop upper section 32 is a reagent carousel 28. Dispensers 26 are removably mounted to reagent tray 29 (FIG. 4) which, in turn, is adapted to engage carousel 28. Reagents may include any chemical or biological material conventionally applied to slides including but not limited to the liquid compositions of this invention, nucleic acid probes or primers, polymerase, primary and secondary antibodies, digestion enzymes, pre-fixatives, post-fixatives, blocking agents, readout chemistry, and counterstains. Reagent dispensers 26 are preferably bar code labeled 27 for identification by the computer. For each slide, a single reagent is applied and then incubated for a precise period of time in a temperature-controlled environment. Mixing of the reagents is accomplished by compressed air jets (air vortex mixers) 42 aimed along the edge of the slide thus causing rotation of the reagent. After the appropriate incubation, the reagent is washed off the slide using nozzles 36. Then the remaining wash buffer volume is adjusted using the volume adjust nozzle 39.

The liquid compositions of this invention may be applied to the slide via nozzle 37. The slide may be unheated (maintained at room temperature) or the slide may be heated to a temperature that is less than the melting point of the embedding material. When the embedding material is paraffin wax, the temperature is about 60° C. The liquid composition, comprising a nonpolar organic solvent is allowed to directly contact the embedded biological material for a defined period of time in order to solubilize the embedding material. Once an amount of embedding material is dissolved from the embedded biological material sample, the solubilized paraffin-based embedding material containing liquid composition may be washed away and, thereafter the biological sample—now essentially deparaffinized—is available for subsequent processing steps. In an alternative embodiment, non-polar organic solvent may be allowed to remain in contact with the biological sample where it acts as a cover material to prevent dehydration of the biological sample and the reagents applied to the biological sample. In this embodiment, air knife 38 preferably divides the paraffin containing liquid composition after which the desired reagents can be applied to the biological sample following which the air knife is ceased and the solubilized paraffin-based embedding materials containing liquid composition covers the applied reagent and biological sample. These steps are repeated as the carousels turn until the deparaffinizing protocol is completed.

In addition to host computer 14, apparatus 10 preferably includes its own microprocessor 44 (FIG. 3) to which information from host computer 12 is downloaded. In particular, the computer downloads to microprocessor 44 both the sequence of steps in a run program and the sensor monitoring and control logic called the “run rules” as well as the temperature parameters of the protocol. Model No. DS2251T 128K from Dallas Semiconductor, Dallas Tex. is an example of a microprocessor that can perform this function.

### EXAMPLES

### Example 1

Special Stains

Various routinely prepared clinical paraffin tissue blocks were cut (5 μm) and placed onto glass slides. Air-dried slides were subjected to: Method 1) manual deparaffinization with xylene (control group) or Method 2) deparaffinization according to the methods of this invention for 12 minutes at 41° C. with NORPAR® 15 (test group) using NexES® Special Stains System manufactured by Ventana Medical Systems, Inc. (Tucson, Ariz.). The NORPAR® 15 containing solublized paraffin embedding material was then washed from the tissue samples using a tris-based washing buffer.

After the embedding material was removed from the biological samples by Method 1 or Method 2, the biological samples were processed for various automated special stain applications. These procedures were performed on a variety of cells stained with a variety of special stains. The special stain tests conducted are reported in Table 1 below. In all cases, the cells that were contacted with the liquid compositions of this invention in order to remove the embedding medium were able to be stained.

TABLE 1

| | | Results | |
|---|---|---|---|
| Special Stains | Tissues | Method 1 | Method 2 |
| AFB III 1 | Lung | Stained | Stained |
| Alcian Blue | Intestine/Salivary | Stained | Stained |
| (pH 2.5) | Gland | | |
| Alcian Yellow | Stomach | Stained | Stained |
| Giemsa Stain | Stomach | Stained | Stained |
| GMS Fungus | Lung | Stained | Stained |
| Iron Stain | Spleen | Stained | Stained |
| Jones 1 | Kidney | Stained | More intensely |
| | | | stained |
| Mucicarmine | Salivery | Stained | Stained |
| Stain | | | |
| PAS- | Kidney | Stained | Stained |
| Hematoxylin | | | |
| Reticulum II 1 | Liver | Stained unstained | Stained |
| | | locations | |
| Steiner 1 | Stomach | Stained | Stained |
| Trichrome III | Kidney | Stained | Stained |
| Blue 5 | | | |

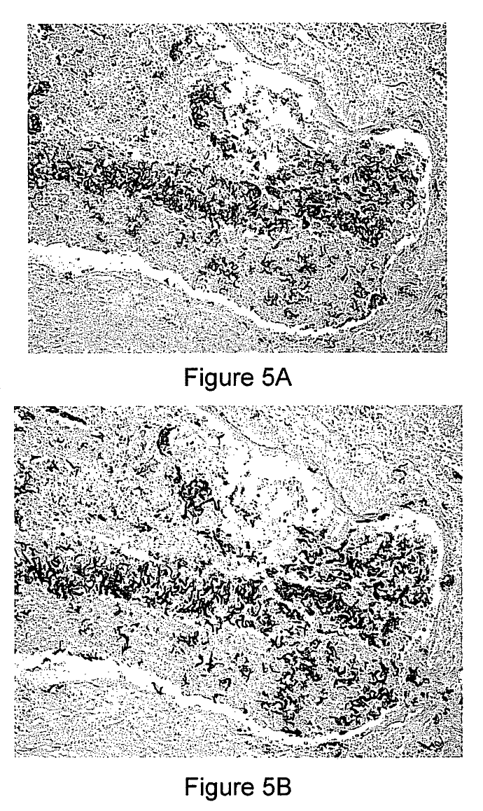

FIGS. 5A-5B show human lung cells stained with AFB III 1 application where the paraffin embedded cells were deparaffinized manually with xylene (FIG. 5A) or deparaffinized with liquid compositions according to the methods of this invention (FIG. 5B). A comparison of FIGS. 5A and 5B demonstrates that the deparaffinization methods of this invention have no adverse effect on the result of AFB III 1 special staining. This indicates that the methods of this invention provide substantially complete deparaffinization of biological samples at low temperatures. Moreover, the results in Table 1 demonstrate that in some instances, the deparaffinization of methods of this invention actually enhance the stainability of certain biological samples in comparison to samples deparaffinized with xylene. The figures demonstrate that the cell staining in FIG. 5B is more robust and intense than the staining in FIG. 5A indicating that the methods of this invention are superior to xylene deparaffinzation methods for exposing cells for subsequent treatment and staining steps.

### EXAMPLE 2

mRNA In Situ Hybridization

Formalin-fixed, paraffin-embedded mouse kidney samples were cut (5 μm) and placed onto glass slides. Air-dried slides were subjected to: Method 1) manual deparaffinization with xylene (control group 1); Method 2) automated heat deparaffinization with an aqueous solution (control group 2); or Method 3) deparaffinization at room temperature (37° C.) for 10 minutes (test group) with NORPAR® 15 on the Discovery® automated in situ hybridization apparatus manufactured by Ventana Medical Systems, Inc. (Tucson, Ariz). Following deparaffinization, all slides were processed for VEGF mRNA ISH using standard techniques.

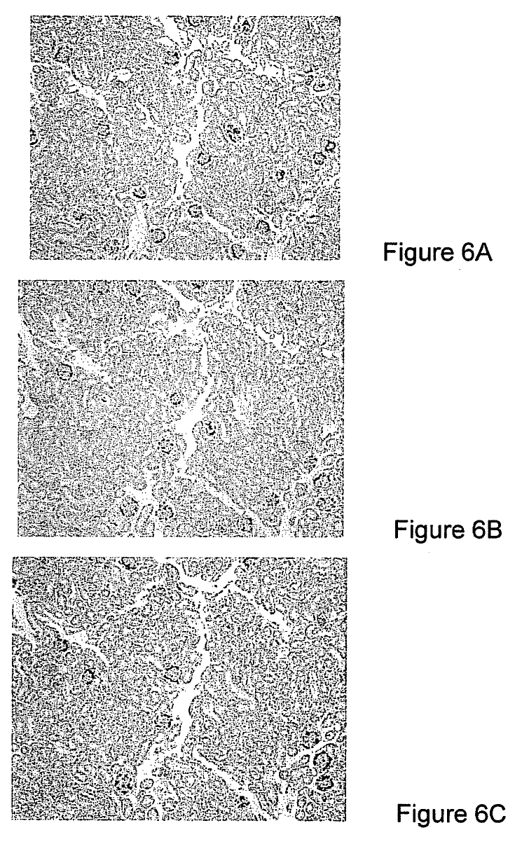

The VEGF ISH results on mRNA deparaffinized by each of the methods above are set forth in the cross sections shown in FIGS. 6A-6C where 6A is the result for section deparaffinized manually with xylene of Method 1; 6B is the result for cells deparaffinized by heating the paraffin embedded tissues to a temperature above the melting point of the embedding paraffin and thereafter removing the liquefied paraffin from the cell with a surfactant containing aqueous solution in which the liquefied paraffin is immiscible of Method 2; and 6C is the result of sections deparaffinized using the methods of this invention. The asterisks in FIGS. 6B and 6C identify identical locations in the material cross sections for comparison purposes. The staining indicates a signal for VEGF mRNA targets.

A comparison of FIG. 6A, 6B and 6C demonstrates that low temperature deparaffinization using the disclosed methods results in visible staining of mRNA in the cell nucleuses. In comparison, the deparaffinization Methods 1 and 2 did not provide visible mRNA in the cell nucleuses. This shows that the disclosed deparaffinization method is superior to prior art methods for exposing cells and other biological material for mRNA ISH detection.

### EXAMPLE 3

Immunohistochemistry

Routinely processed clinical tissue samples were cut (5 μm) and placed onto glass slides. Air-dried slides were subjected to: Method 1) manual deparaffinization with xylene (control group 1); Method 2) automated heat deparaffinization (control group 2); or Method 3) deparaffinization with NORPAR 15 for 10 minutes at room temperature (37° C.) (test group) using the Discovery® automated ISH apparatus manufactured by Ventana Medical Systems, Inc. Following deparaffinization, all slides were processed by ISH for the presence of biological marker CD20.

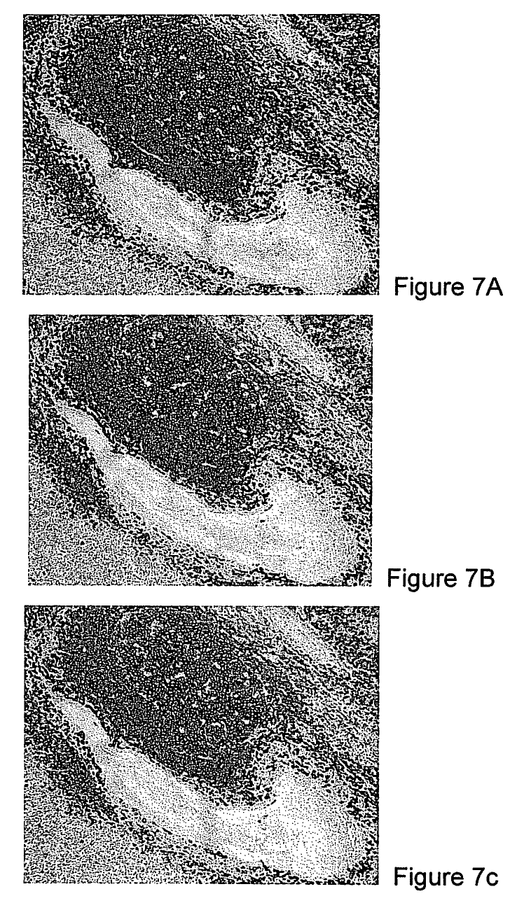

The CD20 results of this example are reported in FIGS. 7A-7C in which 7A are the results of CD20 on tissue sections deparaffinized manually with xylene (Method 1), 7B are the results of CD20 detection on a tissue section deparaffinized using heat and an immiscible liquid (Method 2), and FIG. 7C are the results of CD20 detection on a tissue sample deparaffinized by a method of this invention (Method 3). These results demonstrate that methods of this invention are at least equivalent to the deparaffinization methods of the prior art in exposing cells for subsequent processing in the CD20 IHC detection method. More specifically, the amount of CD20 detected in each sample, which is visible as darker stain spots on the samples, is essentially equivalent for each deparaffinized sample.

Similar results were seen for human brain tissues deparaffinized according to the methods of the present invention and (i) processed to detect the GFAP marker; or (ii) human intestine tissues processed to detect the MA marker. The deparaffinized brain tissues, however, did include some unstained portions.

What is claimed is:

1. A method for removing paraffin-based embedding medium from a paraffin-embedded biological sample, the method comprising the steps of:
(a) loading a plurality of paraffin-embedded biological samples into an automated tissue staining apparatus;
(b) placing a paraffin-solubilizing liquid alkane having from 10 to 16 carbon atoms into direct contact with the biological sample;
(c) maintaining the liquid alkane in contact with the biological sample at a temperature less than the melting point of the paraffin-based embedding medium for a time sufficient for at least a portion of the paraffin-based embedding medium to become soluble in the liquid alkane; and
(d) removing the liquid alkane including solubilized paraffin-based embedding medium from the biological sample to form a deparaffinized biological material wherein the temperature of the biological sample is does not equal or exceed the embedding medium's melting point during steps (b) and (c).

2. The method of claim 1 wherein the temperature of the biological sample is maintained at essentially room temperature during steps (b) and (c).

3. The method of claim 1 wherein the linear alkane having from 10 to 16 carbon atoms is selected from the group consisting of dodecane, pentadecane and mixtures thereof.

4. The method of claim 1 wherein mineral oil is added to the liquid composition.

5. An automated method of deparaffinizing biological samples embedded with a paraffin-based embedding medium comprising the steps of:
(a) placing at least one biological sample embedded with a paraffin-based embedding medium on a support and loading the support into an automated deparaffinization apparatus;
(b) directing a liquid composition comprising a non-polar organic solvent into contact with the biological sample;
(c) maintaining the liquid composition in contact with the paraffin-embedded biological sample for a time sufficient for at least a portion of the paraffin-based embedding medium to become solubilized in the liquid composition; and
(d) removing the liquid composition including soluble embedding medium from the biological sample to form a deparaffinized biological material, wherein steps (b), (c) and (d) are performed by the automated deparaffinization apparatus and wherein the temperature of the biological sample is does not equal or exceed the embedding medium's melting point during steps (b) and (c).

6. The method of claim 5 wherein the temperature of the biological sample is maintained at essentially room temperature during steps (b) and (c).

7. The method of claim 5 wherein the liquid composition is a non-aromatic hydrocarbon having from 6 to 18 carbon atoms.

8. The method of claim 7 wherein the non-aromatic hydrocarbon is an alkane or a linear alkane.

9. The method of claim 7 wherein the non-aromatic hydrocarbon is a linear alkane having from 10 to 16 carbon atoms.

10. The method of claim 7 wherein the non-aromatic hydrocarbon is selected from the group consisting of dodecane, pentadecane and mixtures thereof.

11. The method of claim 5 wherein mineral oil is added to the liquid composition.

12. The method of claim 1 wherein the deparaffinized biological material is further manipulated by contacting the deparaffinized biological material with polynucleotide probes that are complementary to target mRNA sequences in situ.

13. A method for detecting RNA/DNA in paraffin-embedded biological samples comprising the steps of:
(a) contacting a paraffin-embedded biological sample with a nonpolar organic solvent at a temperature below the melting point of the paraffin;
(b) gently agitating the nonpolar organic solvent to enhance the solubilization of the paraffin in the nonpolar organic solvent;
(c) exchanging the nonpolar organic solvent in the deparaffinized biological sample with an aqueous medium; and
(d) contacting the deparaffinized biological sample with a polynucleotide probe capable of being detected.

14. The method of claim 13 wherein the temperature of the biological sample is does not equal or exceed the embedding medium's melting point during steps (a)-(b).

15. The method of claim 13 wherein the temperature of the biological sample is maintained at essentially room temperature during steps (a)-(b).

16. The method of claim 13 wherein the nonpolar organic solvent is mineral spirits.

17. The method of claim 13 wherein the nonpolar organic solvent is a linear alkane having from 10 to 16 carbon atoms.

18. The method of claim 17 wherein the linear alkane is selected from the group consisting of dodecane, pentadecane and mixtures thereof.

19. The method of claim 15 wherein mineral oil is added to the nonpolar organic solvent prior to step (a).

20. The method of claim 15 wherein the polynucleotide probe is capable of being visibly detected.
